(19) United States
(12) Patent Application Publication
(10) Pub. No.: US 2017/0188008 A1
(43) Pub. Date: Jun. 29, 2017

(54) METHOD AND DEVICE FOR GENERATING DEPTH MAP

(71) Applicant: Korea University Research and Business Foundation, Seoul (KR)

(72) Inventors: Hyoung Joong Kim, Seoul (KR); Young-Jin Choi, Seoul (KR)

(73) Assignee: Korea University Research and Business Foundation, Seoul (KR)

(21) Appl. No.: 15/129,682

(22) PCT Filed: Feb. 10, 2015
(86) PCT No.: PCT/KR2015/001332

§ 371 Date: Sep. 27, 2016

(30) Foreign Application Priority Data
Feb. 13, 2014 (KR) 10-2014-0016447

(51) Int. Cl. H04N 13/00; G06K 9/46; G06T 5/00; G06T 7/11

(52) U.S. Cl. CPC H04N 13/0055; H04N 13/0022; G06T 7/11; G06K 9/4604; G06T 5/002; G06T 2207/30204

(57) ABSTRACT

A method of providing a stereoscopic image from a monocular image is provided. The method may include the steps of: (a) partitioning an original image; (b) generating a combination image by combining a partitioned image with the original image, and receiving input of specific image object marker information and input of background marker information on the combination image, where the specific image object marker information relates to a specific image object of which extraction is desired; (c) extracting a specific image object from the combination image; (d) performing defocusing by applying area processing on the combination image, in which the specific image object has been extracted, to adjust blurring; and (e) adjusting a depth value of the specific image object.

### CROSS-REFERENCE TO RELATED APPLICATIONS

This application is a National Phase Application of PCT International Application No. PCT/KR2015/001332, which was filed on Feb. 10, 2015, and which claims priority from Korean Patent Application No. 10-2014-0016447 filed with the Korean Intellectual Property Office on Feb. 13, 2014. The disclosures of the above patent applications are incorporated herein by reference in their entirety.

### BACKGROUND

1. Technical Field

The present invention relates to a method and apparatus for generating a depth map, more particularly to a method and apparatus used to generate a depth map for converting a 2-dimensional, monocular image into a stereoscopic image.

2. Description of the Related Art

In recent times, there has been active ongoing research in the fields of display devices and image contents that provide stereoscopic images, and a large portion of stereo rigs and 3-dimensional stereoscopic displays used by research institutions or companies for stereoscopic imaging is currently available in the market. Generally, providing a stereoscopic image may entail capturing images using two or more cameras, editing the images, and displaying parallax-incorporated images to the left and right eyes so that the user can view the image as a stereoscopic image.

In providing a stereoscopic image, one may employ several cameras during photography, in order that two or more viewpoints may be obtained for a single scene. However, there is a limit to the number of cameras that can be operated and processed concurrently, and there is also a limit to how small the gap between the cameras can be made. Hence, generating images corresponding to virtual viewpoints that are in-between the images captured with a limited number of cameras would allow a more effective production of a stereoscopic image. To generate such images for virtual viewpoints, a depth map may be utilized, which is a map that includes depth information.

Various techniques can be used to obtain depth information, examples of which include the stereo matching method, the TOF (time of flight) method, which involves directly measuring the distance of an object within a scene, and other methods. However, these techniques require binocular photography, which uses two or more cameras, and cannot be used, or can only be used in a limited manner, for an image obtained by monocular photography, i.e. using one camera. Thus, despite advances in 3-dimensional imaging technology, it is difficult to obtain satisfactory results with the method of extracting depth information for implementing a stereoscopic image from a monocular photography image compared to implementing a stereoscopic image from binocular or multi-ocular images.

### SUMMARY OF THE INVENTION

An aspect of the present solution, conceived in order to resolve the problem described above, is to generate a depth map for implementing a stereoscopic image from a 2-dimensional image obtained by monocular photography.

A method of generating a depth map, which is a method that can provide a stereoscopic image from a monocular image, may include the steps of: (a) partitioning an original image; (b) generating a combination image by combining a partitioned image with the original image, and receiving input of specific image object marker information and input of background marker information on the combination image, where the specific image object marker information relates to a specific image object of which extraction is desired; (c) extracting a specific image object from the combination image; (d) performing defocusing by applying area processing on the combination image, in which the specific image object has been extracted, to adjust blurring; and (e) adjusting a depth value of the specific image object.

Here, the step of partitioning the original image can include partitioning the original image using a SLIC (simple linear iterative clustering) algorithm.

The step of extracting the specific image object can include extracting using a MSRM (maximal similarity-based region merging) algorithm.

Also, the step of extracting the specific image object from the combination image can include extracting a multiple number of specific image objects.

Here, the specific image objects can be made not to overlap.

An apparatus for generating a depth map, which is an apparatus that can provide a stereoscopic image from a monocular image, may include: a partitioning unit configured to partition an original image; an image extraction unit configured to extract a specific image object from a combination image that is a combination of a partitioned image from the partitioning unit and the original image; and a generating unit configured to generate the combination image by combining the original image with the partitioned image from the partitioning unit, perform defocusing by applying area processing on the combination image to adjust blurring, and adjust a depth value of the specific image object to generate the depth map.

Here, the apparatus for generating a depth map can further include a user interface that is configured to receive input of specific image object marker information, receive input of background marker information, and receive input of an adjusted depth value for the specific image object.

Here, the partitioning unit can partition the original image by using a SLIC (simple linear iterative clustering) algorithm, and the image extraction unit can extract the specific image object by using a MSRM (maximal similarity-based region merging) algorithm.

With the method and apparatus for generating a depth map, it is possible to provide a clearer feeling of stereoscopy when a 2-dimensional image obtained by monocular photography is converted into a stereoscopic image, as well as to prevent distortions in the stereoscopic image due to lighting or shadows.

### BRIEF DESCRIPTION OF THE DRAWINGS

FIG. 1 is a flowchart of a method of generating a depth map.

FIG. 2 shows an example of an original picture for which a depth map is to be generated.

FIG. 3 shows a partitioned image obtained by partitioning the original image.

FIG. 4 shows a combination image obtained by combining the partitioned image with the original image.

FIG. 5 shows a picture in which marker information has been inputted to the combination image.

FIG. 6 shows a picture illustrating a process in which partitioned groups are merged together.

FIG. 7 shows a picture in which a specific image object has been extracted.

FIG. 8 shows an actual picture of a depth map obtained with a method of generating a depth map.

FIG. 9 is a function block diagram of an apparatus for generating a depth map.

### DETAILED DESCRIPTION OF THE INVENTION

Embodiments of the inventive concept may be variable in various forms and the scope of the inventive concept may not be construed as restricting the following embodiments. Other aspects, advantages, and salient features of the inventive concept will become apparent to those skilled in the art from the following detailed embodiments. Various embodiments described herein, however, may not be intentionally confined in specific embodiments, but should be construed as including diverse modifications, equivalents, and/or alternatives.

While the terms such as ‘first’ or ‘second, and the like may be used to qualify various elements regardless of their order and/or priority, simply differentiating one from another, but do not limit those elements thereto. For example, a first element may be referred to as a second element and vice versa without departing from the scope of the inventive concept.

As used herein, if one element is referred to as being coupled with/to’ or ‘connected with/to’, including its similar expressions, another element, it should be understood that the former may be directly coupled with the latter, or connected with the latter via an intervening element (e.g., a third element). Otherwise, it will be understood that if one element is referred to as being ‘directly coupled with/to’ or ‘directly connected with/to’ another element, it may be understood that there is no intervening element (e.g., a third element) existing between them. Additionally, expressions describing relations between elements, for example, ‘between’, ‘directly between’, or ‘directly adjacent to’, will be also construed in the same manner.

The terms used in this specification are just used to describe various embodiments of the inventive concept and may not be intended to limit the scope of the inventive concept. In the description, the terms of a singular form may also include plural forms unless otherwise specified. The terms ‘include’ or ‘have’ and its diverse inflections or conjugations, as used herein, may be construed such that any one of a feature, a number, a step, an operation, an element, a component, or a combination of them does not exclude presence or addition of one or more different constitutions, features, numbers, steps, operations, elements, components, or combinations of them.

Unless otherwise defined herein, all the terms used herein (including technical or scientific terms) may have the same meaning that is generally acceptable by universal technology in the related art of the inventive concept. It will be further understood that terms, which are defined in a dictionary and commonly used, may also be interpreted as is customary in the relevantly related art and/or as is same in the description of the present application. Even in the case of terminological expression with insufficient clarification, such terms may not be conceptualized or overly interpreted in formality.

Certain embodiments of the present invention are described below in more detail with reference to the accompanying drawings.

A method of generating a depth map, which may be a method of generating a depth map for providing a stereoscopic implementation from a monocular image, may include the steps of partitioning an original image (S100), generating a combination image by combining the partitioned image with the original image (S200), receiving input of specific image object marker information, regarding a specific image object of which extraction is desired, and receiving input of background marker information on the combination image (S300), extracting the specific image object from the combination image (S400), performing defocusing by applying area processing on the combination image, in which the specific image object has been extracted, to adjust blurring (S500), adjusting the depth value of the specific image object (S600), and generating the depth map (S700).

A depth map refers to a map that represents the differences in 3-dimensional distances between objects in an image. Each pixel may be given a value between 0 and 255, and with such a depth map and a 2-dimensional image, it is possible to obtain a stereoscopic image.

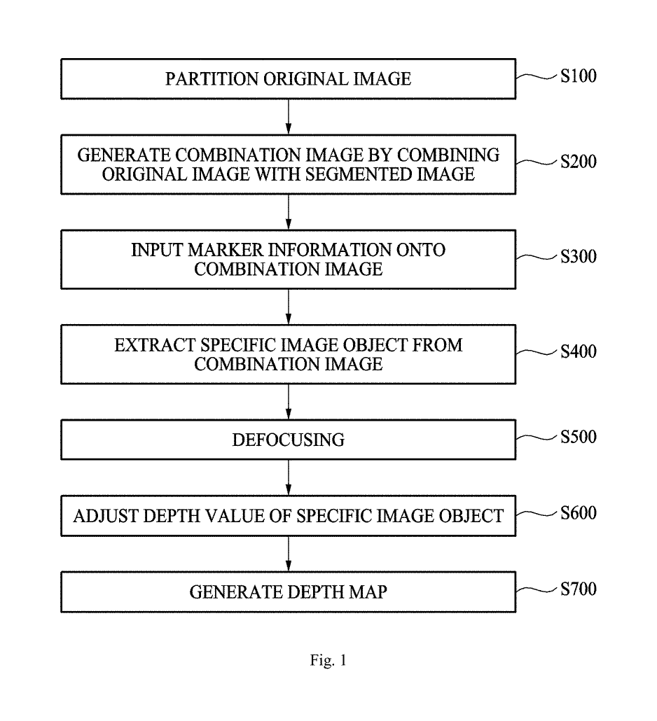

FIG. 1 is a flowchart of a method of generating a depth map.

Looking at the method of generating a depth map with reference to FIG. 1, generating a depth map may first entail partitioning an original image (S100). Partitioning the original image is the step in which all objects within the original picture is partitioned, before a specific image object designated by the user is distinguished from the background image. While any of a large variety of methods can be used in partitioning the original image, the step of partitioning an original image can be performed by way of a SLIC (simple linear iterative clustering) algorithm. The SLIC algorithm is a technique used in the field of superpixels and can be used to reduce the amount of information of the original picture. Pixels of the original picture having the same color, within the range of a certain level of similarity, may be lumped together to form a partition group.

The partitioned image, obtained by partitioning the original image using the SLIC algorithm, may be combined with the original image to generate a combination image (S200). The combination image shows the user how the actual original picture has been partitioned and makes it easier to distinguish a specific image object from the background image.

One reason for attempting to partition the original image as above is that, when the pixel values assigned to the respective pixels of the image are similar at the boundary portions between a specific image object and the background image, it can be difficult to clearly define the boundary, and this may cause the shape of an object within the specific image object to become distorted. Partitioning the original image can help prevent occurrences in which the intended shape is not correctly expressed due to such distortions.

A partitioned image obtained by actually partitioning an original image with the SLIC algorithm as well as the combination image obtained by combining the original image and the partitioned image are shown below using an actual picture as an example.

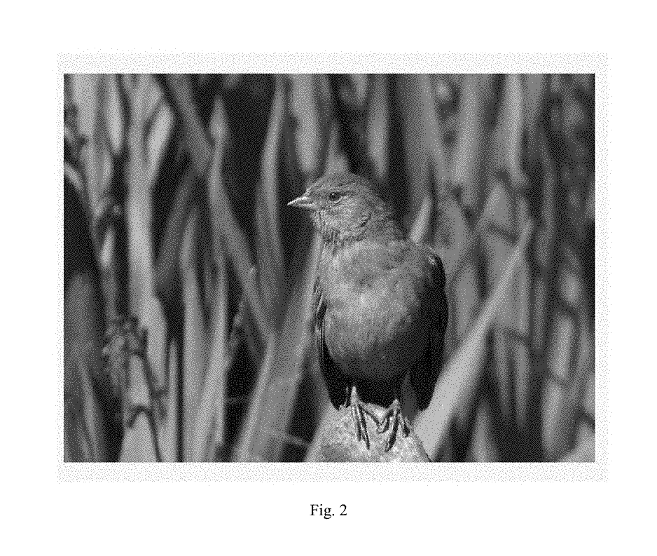

FIG. 2 shows an example of an original picture for which a depth map is to be generated.

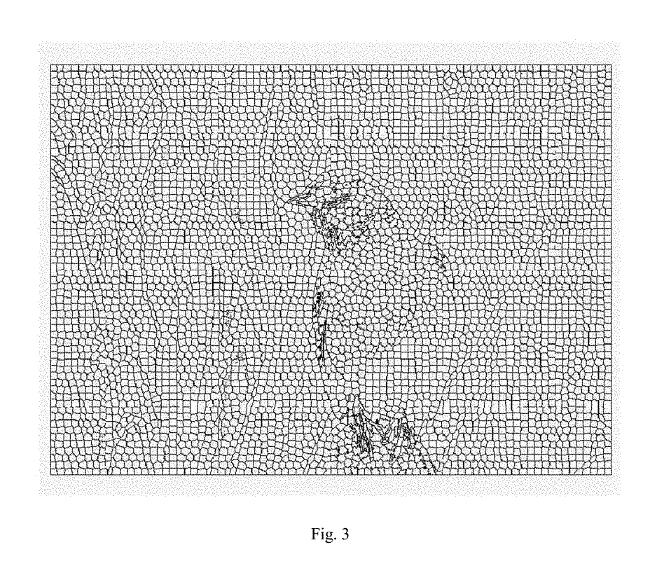

FIG. 3 shows a partitioned image obtained by partitioning the original image.

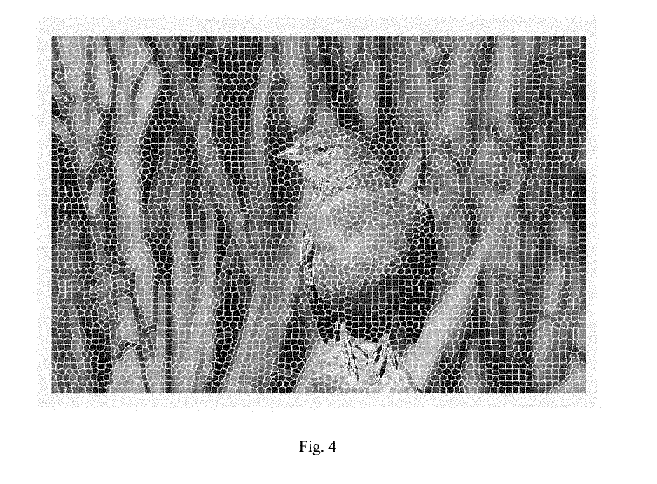

FIG. 4 shows a combination image obtained by combining the partitioned image with the original image.

In FIG. 2, the bird is set as the specific image object, and the remaining portions are set as the background image. FIG. 3 is the image obtained after the original picture shown in FIG. 2 was partitioned, where pixels of the original picture having the same color within the range of a level of similarity were lumped together into partition groups according to the SLIC algorithm. FIG. 4 is the combination image, which was obtained by combining FIG. 2 and FIG. 3, and which allows the user to see how the specific image object and the background image have been partitioned.

If a partitioned image of the original image were not generated, there may be occurrences in which it is difficult to clearly distinguish the boundary in the specific image object, as already described above. For example, in FIG. 2, the bird's feet and the portion where the bird's feet are standing can have similar colors, with the result that the outline of the bird's feet may not be clearly defined.

Thus, in order to clearly show the shape of the specific image object, it may be desirable to partition the original image, and in some scenarios, the partitioning of the original image may be attempted by way of a SLIC algorithm.

Next, marker information may be received as input for the combination image (S300). This step may entail the actual user clearly differentiating the specific image object and the background image.

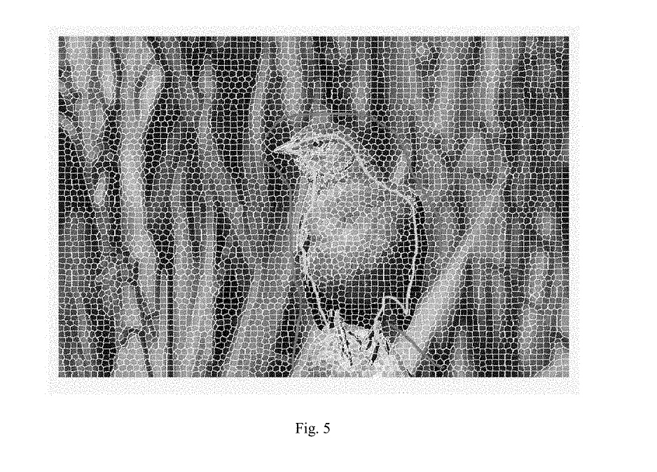

FIG. 5 shows a picture in which marker information has been inputted to the combination image. The marker information may be divided into specific image object marker information and background marker information.

The specific image object marker information may refer to information that denotes the portion of the image that is to project forward from the 2-dimensional image. In FIG. 5, the line shown as the outline drawn inside the bird is the specific image object marker information denoted by the user.

The background marker information may be the line shown as the outline drawn on the outside of the bird and does not necessarily have to be connected. Such marker information may serve as the starting point at which the MSRM algorithm, described later on, may begin. A more detailed description is provided below in the section describing the MSRM algorithm.

After the marker information is inputted to the combination image, the specific image object may be extracted from the combination image (S400). In some scenarios, the method of extracting the specific image object may employ the MSRM (maximal similarity-based region merging) algorithm. However, the method is not necessarily limited to this algorithm.

Using the MSRM algorithm, groups of similar types from among the partitioned groups may again be aggregated into a larger group. As the initial partition groups close to the object designated by the user and the background, i.e. the specific image object marker information and the background marker information, are merged with the object or background, respectively, the segments forming the partition groups generated during the step of partitioning the original image described above disappear.

With respect to the segments forming the partition groups, the MSRM algorithm may be performed, beginning with the marker information inputted by the user as the starting point. In particular, performing the MSRM algorithm can entail applying the MSRM algorithm first on the background region beginning with the background marker information and then applying the MSRM algorithm beginning with the specific image object marker information. However, the present solution is not limited to a particular order for performing the MSRM algorithm, furthermore, the algorithm can also be performed on both regions simultaneously.

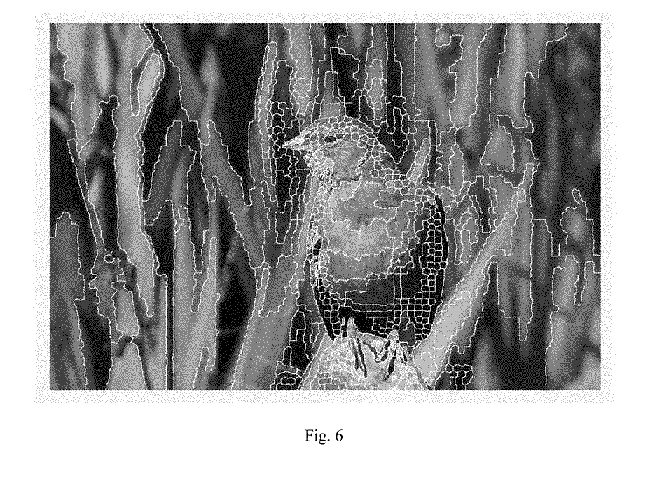

FIG. 6 shows a picture illustrating a process in which partitioned groups are merged together. As illustrated in FIG. 6, the MSRM algorithm can be performed, beginning with the actual marker information as the starting points, so that the partition groups may be merged together.

The step of extracting the specific image object can include extracting a multiple number of specific image objects. In this case, multiple sets of specific image object marker information and background marker information can be received as input. When extracting multiple specific image objects, there may not be overlapping areas between the specific image objects.

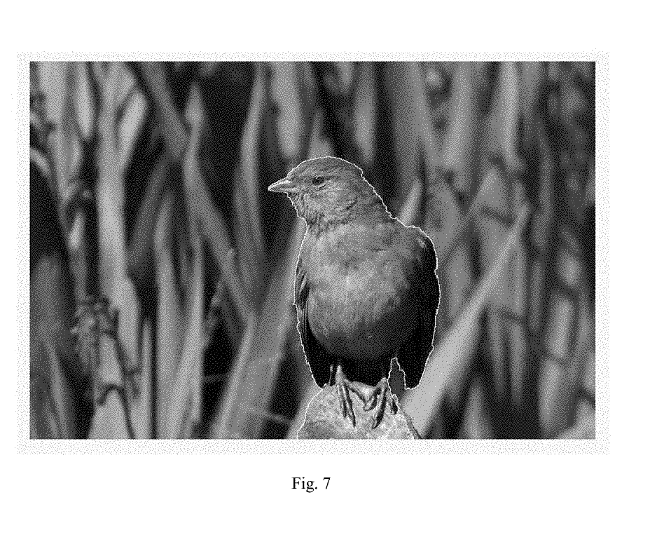

FIG. 7 shows a picture in which a specific image object has been extracted.

As illustrated in FIG. 7, when the process of merging the partition groups together by way of the MSRM algorithm is completed, the outline of the specific image object may be derived.

The specific image object distinguished from the background image by way of the MSRM algorithm can be distinguished from the background image by the outline, so that only the image lying at the focal distance from the lens at the time of photography is distinguished from the remaining portions of the image. In other words, the picture shown in FIG. 7 is a picture focused on the bird and not on the leaves forming parts of the background. In such an image, the image of the bird, on which the focus is set, may be expressed clearly, whereas the background image may be expressed less clear.

Thus, depending on which object the lens is focused on, the 2-dimensional image can be divided into a clear portion and a less clear portion. This as yet cannot be regarded as a 3-dimensional image.

Thus, in some scenarios, a defocusing step may be performed (S500) in which the blurring is adjusted by performing area processing on the specific image object.

Blurring, sometimes expressed in regard to smoothness, refers to the phenomenon in which a color appears broader or smeared in an image. Area processing may be a procedure in which several pixels are assigned new pixel values in correlation with one another using an algorithm that modifies values based on the original value of each pixel and the value of neighboring pixels. Ultimately, the defocusing step is the step of adjusting blurring by way of area processing applied to the combination image in which the specific image object has been extracted. In order that the specific image object can be seen as projected forward, its smoothness may be decreased for greater clarity, and in order that the background image can be seen as receded backward, its smoothness may be increased. Due to the defocusing step, new pixel values may be generated, which may then be applied to the combination image.

After the defocusing step, for allowing the specific image object extracted in the combination image to be seen as protruding forward, the depth value of the specific image object may be adjusted (S600).

The step of adjusting the depth value of the specific image object (S600) is to allow a specific image object to appear to be projecting forward more clearly, through a process of adding to or subtracting from the depth value of the specific image object, in order to prevent undesired phenomena such as a part of the specific image object appearing as if it is receded into the background, due to an excessively small difference between the depth value of said portion and the depth value of the background image, or a part of the specific image object appearing excessively projected outward.

Thus, a depth map may be generated (S700) in which the depth value of the specific image object has been adjusted and an adjusted depth value has been assigned to each of the pixels.

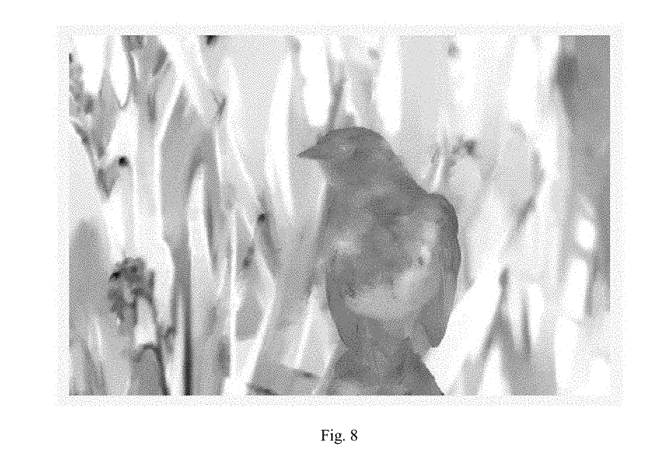

FIG. 8 shows an actual picture of a depth map obtained with a method of generating a depth map.

In the depth map of FIG. 8, in which each pixel is expressed with a value between 0 and 255, parts having higher proportions of black colors (high values) are the parts projected forward, while parts having higher proportions of white colors (low values) are the parts receded backward to form the background. It can be seen from the depth map of FIG. 8 that the bird, which was extracted as a specific image object, is represented by projected parts having higher proportions of black colors, whereas the leaves shown as the background are represented by the background having higher proportions of white colors.

The present solution can be implemented in the form of computer-readable program instructions on a recorded medium readable by a computer. A recorded medium readably by a computer may be any type of device storing data that can be read by a computer system. Examples of a recorded medium readable by a computer include ROM, RAM, CD-ROM, magnetic tape, floppy discs, optical data storage devices, and the like.

Moreover, a recorded medium readable by a computer can be distributed over a computer system connected by a network, so that the computer-readable program instructions can be stored and executed in a distributed manner.

Also, the functional programs, code, and code segments for implementing the present solution can be readily inferred by programmers familiar with the field of art to which the present solution pertains.

An apparatus for generating a depth map, which may be an apparatus for generating a depth map to provide a stereoscopic implementation from a monocular image, may include a partitioning unit 10 that partitions an original image, an image extraction unit 20 that extracts a specific image object from a combination image, which is a combination of the partitioned image from the partitioning unit 10 and the original image, and a generating unit 30 that generates the combination image by combining the original image with the partitioned image from the partitioning unit 10, performs defocusing by applying area processing on the combined image to adjust blurring, and generates the depth map by adjusting the depth value of the specific image object.

The apparatus for generating a depth map can further include a user interface 40 that receives input of specific image object marker information, receives input of background marker information, and receives input of an adjusted depth value for the specific image object.

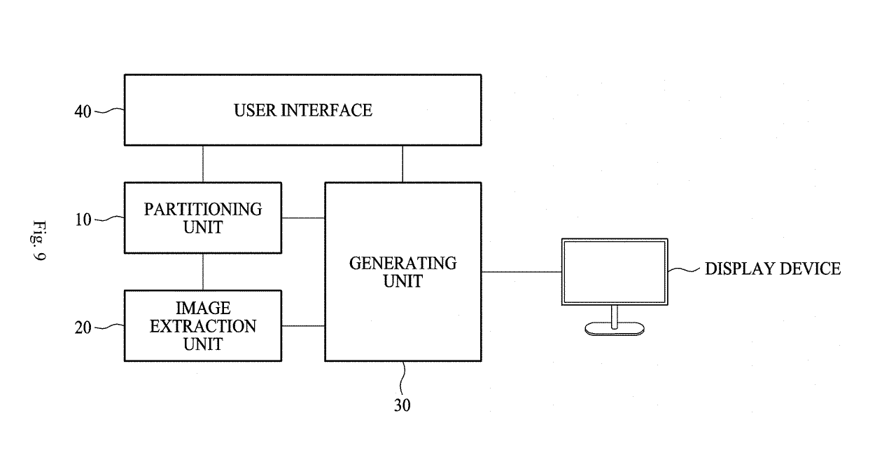

FIG. 9 is a function block diagram of an apparatus for generating a depth map.

A more detailed description of the apparatus for generating a depth map is provided below with reference to FIG. 2 through FIG. 9.

An original image, such as that of FIG. 2, can be inputted to the apparatus for generating a depth map via the user interface 40. Alternatively, the input to the apparatus for generating a depth map can be made by way of a storage medium (not shown) on which the original image is stored. When the original image is inputted to the apparatus for generating a depth map, the partitioning unit 10 may partition the original image. As already described above, the partitioning can be performed based on a SLIC (simple linear iterative clustering) algorithm. The image partitioned according to the SLIC algorithm (FIG. 3) may be transmitted together with the original image to the generating unit 30, and the generating unit 30 may generate a combination image (FIG. 4) of the partitioned image and the original image combined together. The combination image may be shown on a display device, marker information inputted via the user interface 40 may be shown on the combination image, and the combination image including the marker information (FIG. 5) may be transmitted by the generating unit 30 to the image extraction unit 20.

The image extraction unit 20 may extract the specific image object based on the marker information. The method of extracting the specific image object may be performed using a MSRM (maximal similarity-based region merging) algorithm. FIG. 6 shows a picture representing the procedure of extracting the specific image object by way of the MSRM (maximal similarity-based region merging) algorithm.

When the MSRM algorithm of the image extraction unit 20 is completed, an image may be obtained in which the specific image object is distinguished by an outline, such as in the image of FIG. 7. The combination image including the specific image object extracted at the image extraction unit 20 may be transmitted to the generating unit 30. The generating unit 30 may perform defocusing by applying area processing on the combination image, in which the specific image object has been extracted, to adjust blurring, and may adjust the depth values for the specific image object, to generate the depth map.

With the depth map thus obtained by this apparatus for generating a depth map, even a 2-dimensional image acquired using a monocular imaging technique can be converted into a stereoscopic image of which the clarity and sense of 3-dimensionality are comparable to a stereoscopic image obtained by binocular or multi-ocular photography.

While the present invention has been described with reference to the embodiment illustrated in the drawings, this is merely provided as an example, and the person having ordinary skill in the art would understand that various modifications and equivalent embodiments can be derived from said example. The true scope of the invention should thus be interpreted from the technical spirit defined in the appended claims.

What is claimed is:

1. A method of generating a depth map for providing a stereoscopic image from a monocular image, the method comprising:
(a) partitioning an original image;
(b) generating a combination image by combining a partitioned image with the original image, receiving input of specific image object marker information and receiving input of background marker information on the combination image, the specific image object marker information relating to a specific image object to be extracted;
(c) extracting a specific image object from the combination image;
(d) performing defocusing by applying area processing on the combination image, in which the specific image object has been extracted, to adjust blurring; and
(e) adjusting a depth value of the specific image object.

2. The method of generating a depth map according to claim 1, wherein said step (a) comprises partitioning the original image by using a SLIC (simple linear iterative clustering) algorithm.

3. The method of generating a depth map according to claim 1, wherein said step (c) comprises extracting using a MSRM (maximal similarity-based region merging) algorithm.

4. The method of generating a depth map according to claim 1, wherein said step (c) comprises extracting a plurality of specific image objects.

5. The method of generating a depth map according to claim 4, wherein the plurality of specific image objects do not overlap.

6. A computer-readable recorded medium having recorded thereon a program of instructions executed to perform the method of claim 1.

7. An apparatus for generating a depth map for providing a stereoscopic image from a monocular image, the apparatus comprising:
a partitioning unit configured to partition an original image;
an image extraction unit configured to extract a specific image object from a combination image, the combination image obtained by combining a partitioned image from the partitioning unit with the original image; and
a generating unit configured to generate the combination image by combining the original image with the partitioned image from the partitioning unit, perform defocusing by applying area processing on the combination image to adjust blurring, and adjust a depth value of the specific image object to generate the depth map.

8. The apparatus for generating a depth map according to claim 7, further comprising a user interface configured to receive input of specific image object marker information, receive input of background marker information, and receive input of an adjusted depth value for the specific image object.

9. The apparatus for generating a depth map according to claim 7, wherein the partitioning unit partitions the original image by using a SLIC (simple linear iterative clustering) algorithm, and
the image extraction unit extracts the specific image object by using a MSRM (maximal similarity-based region merging) algorithm.
